(19) United States
(12) Patent Application Publication
(10) Pub. No.: US 2020/0215584 A1
(43) Pub. Date: Jul. 9, 2020

(54) Washing System

(71) Applicant: Marcus Alan Wells, II, Orange Park, FL (US)

(72) Inventor: Marcus Alan Wells, II, Orange Park, FL (US)

(21) Appl. No.: 16/727,148

(22) Filed: Dec. 26, 2019

Related U.S. Application Data
(60) Provisional application No. 62/789,234, filed on Jan. 7, 2019.

(51) Int. Cl. B08B 3/04; B60S 3/06; B08B 1/00; B08B 1/04; B08B 3/02

(52) U.S. Cl. CPC B08B 3/041; B60S 3/06; B08B 3/022; B08B 1/04; B08B 1/002

(57) ABSTRACT

Disclosed herein is a washing system, in accordance with some embodiments. Accordingly, a washing system may include a frame, at least one brush, at least one cleaning agent dispenser, a plurality of wheels, at least one actuator, a power source and a controller. a frame configured to be arranged in a plurality of frame configurations. Further, at least one operational frame configuration of the plurality of frame configurations may include a passageway. Further, the at least one brush coupled to the frame. Further, the at least one cleaning agent dispenser mounted on the frame. Further, the plurality of wheels mounted on the frame. Further, the at least one actuator operationally coupled with the at least one wheel. Further, the power source electrically coupled with the at least one actuator. Further, the controller communicatively coupled with the at least one actuator.

### RELATED APPLICATION(S)

Under provisions of 35 U.S.C. § 119e, the Applicant(s) claim the benefit of U.S. provisional application No. 62/789,234 filed Jan. 7, 2019, which is incorporated herein by reference.

### TECHNICAL FIELD

Generally, the present disclosure relates to the field of washing, cleaning, or drying machines. More specifically, the present disclosure relates to a washing system.

### BACKGROUND

Existing techniques for washing and/or cleaning vehicles with a washing apparatus are deficient with regard to several aspects. For instance, current technologies do not allow the user to retract and/or fold the washing apparatus when not in use so as to enhance portability. Furthermore, conventional washing apparatuses that are considered to be portable are also deficient with regard to several aspects. For instance, current portable washing apparatuses require a significant amount of labor and energy because an individual may have to operate the apparatus by their hand.

Therefore, there is a need for improved washing system that may overcome one or more of the above-mentioned problems and/or limitations.

### BRIEF SUMMARY

This summary may be provided to introduce a selection of concepts in a simplified form, that are further described below in the Detailed Description. This summary may be not intended to identify key features or essential features of the claimed subject matter. Nor may be this summary intended to be used to limit the claimed subject matter's scope.

Disclosed herein is a washing system, in accordance with some embodiments. Accordingly, the washing system may include a frame, at least one brush, at least one cleaning agent dispenser, a plurality of wheels, at least one actuator, a power source and a controller. Further, the frame configured to be arranged in a plurality of frame configurations. Further, at least one operational frame configuration of the plurality of frame configurations may include a passageway. Further, the passageway may be configured to partly encompass at least one object. Further, the at least one brush coupled to the frame. Further, the at least one brush may be configured to perform at least one brushing action on the at least one object. Further, the at least one cleaning agent dispenser mounted on the frame. Further, the at least one cleaning agent dispenser may be configured to perform at least one cleaning agent dispensing action. Further, the at least one cleaning agent dispenser may include at least one inlet port and at least one outlet port. Further, the at least one inlet port and the at least one outlet port may be fluidly coupled. Further, the at least one inlet port may be configured to receive at least one cleaning agent. Further, the at least one outlet port may be configured to dispense the at least one cleaning agent. Further, the plurality of wheels mounted on the frame. Further, the plurality of wheels may be configured to facilitate the movement of the frame on a surface in at least one direction. Further, the at least one actuator operationally coupled with the at least one wheel. Further, the at least one actuator may be configured to perform at least one actuator operation. Further, the at least one actuator operation may include rotating the at least one wheel. Further, the power source electrically coupled with the at least one actuator. Further, the power source may be configured to provide electrical power to the at least one actuator. Further, the controller communicatively coupled with the at least one actuator. Further, the at least one actuator may be configured to control the at least one actuator.

Further disclosed herein is a washing system, in accordance with some embodiments. Accordingly, the washing system may include a frame, at least one brush, at least one cleaning agent dispenser, a plurality of wheels, at least one actuator, a power source and a controller. Further, the frame configured to be arranged in a plurality of frame configurations. Further, at least one operational frame configuration of the plurality of frame configurations may include a passageway. Further, the passageway may be configured to partly encompass at least one object. Further, the at least one brush movably coupled to the frame using at least one brush-movement mechanism. Further, the at least one brush may be configured to perform at least one brushing action on the at least one object. Further, the at least one brush-movement mechanism may be configured to provide at least one brush movement to the at least one brush. Further, the at least one brush movement may facilitate the at least one brushing action. Further, the at least one cleaning agent dispenser mounted on the frame. Further, the at least one cleaning agent dispenser may be configured to perform at least one cleaning agent dispensing action. Further, the at least one cleaning agent dispenser may include at least one inlet port and at least one outlet port. Further, the at least one inlet port and the at least one outlet port may be fluidly coupled. Further, the at least one inlet port may be configured to receive at least one cleaning agent. Further, the at least one outlet port may be configured to dispense the at least one cleaning agent. Further, the plurality of wheels mounted on the frame. Further, the plurality of wheels may be configured to facilitate the movement of the frame on a surface in at least one direction. Further, the at least one actuator operationally coupled with the at least one wheel. Further, the at least one actuator may be configured to perform at least one actuator operation. Further, the at least one actuator operation may include rotating the at least one wheel. Further, the power source electrically coupled with the at least one actuator. Further, the power source may be configured to provide electrical power to the at least one actuator. Further, the controller communicatively coupled with the at least one actuator. Further, the controller may be configured to control the at least one actuator.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text may be included for illustrative, non-limiting, explanatory purposes of certain embodiments detailed in the present disclosure.

FIG. 1 is an illustration of an online platform consistent with various embodiments of the present disclosure.

FIG. 2 is a front view of a washing system, in accordance with some embodiments.

FIG. 3 is a top view of the washing system, when the washing system is folded into half using a collapsing mechanism, in accordance with some embodiments.

FIG. 4 is a perspective view of the washing system, when the washing system is folded into half using the collapsing mechanism, in accordance with some embodiments.

FIG. 5 is a perspective view of the washing system, in accordance with some embodiments.

FIG. 6 is a perspective view of the washing system with a vehicle entering a passageway, in accordance with some embodiments.

FIG. 7 is a partial view of the washing system, in accordance with some embodiments.

FIG. 8 is a partial view of leg brushes of the washing system, in accordance with some embodiments.

FIG. 9 is a partial view of a horizontal head bar of the washing system, in accordance with some embodiments.

FIG. 10 is a partial view of a horizontal head bar of the washing system, in accordance with some embodiments.

FIG. 11 is a partial view of a horizontal head bar of the washing system with at least one detergent dispenser, in accordance with some embodiments.

FIG. 12 is a partial view of a horizontal head bar of the washing system with at least one water dispenser, in accordance with some embodiments.

FIG. 13 is a close-up view of the washing system with at least one detergent dispenser, in accordance with some embodiments.

FIG. 14 is a close-up view of the washing system with at least one water dispenser, in accordance with some embodiments.

FIG. 15 is a close-up view of the washing system with at least one inlet port, in accordance with some embodiments.

FIG. 16 is a front view of a washing system, in accordance with some embodiments.

FIG. 17 is a perspective view of the washing system, in accordance with some embodiments.

FIG. 18 is a perspective view of the washing system with a vehicle entering a passageway, in accordance with some embodiments.

FIG. 19 is a close-up view of the washing system with at least one inlet port, in accordance with some embodiments.

FIG. 20 is a block diagram of a computing device for implementing the methods disclosed herein, in accordance with some embodiments.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” may be considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it may be to be understood that this disclosure may be illustrative and exemplary of the present disclosure, and are made merely for the purposes of providing a full and enabling disclosure. The detailed disclosure herein of one or more embodiments may be not intended, nor may be to be construed, to limit the scope of patent protection afforded in any claim of a patent issuing here from, which scope may be to be defined by the claims and the equivalents thereof. It may be not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it may be intended that the scope of patent protection may be to be defined by the issued claim(s) rather than the description set forth herein.

Additionally, it may be important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it may be intended that the meaning of the term as understood by the ordinary artisan should prevail.

Furthermore, it may be important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure may be defined by the claims found herein and/or issuing here from. The present disclosure contains headers. It should be understood that these headers are used as references and are not to be construed as limiting upon the subjected matter disclosed under the header.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data there between corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

Overview:

According to some embodiments, a personal collapsible auto vehicle washing apparatus configured to facilitate washing, and/or rinsing vehicles is disclosed. Accordingly, the personal collapsible auto vehicle washing apparatus, in an instance, may comprise of an inverted U-shaped frame that may include multiple components configured to facilitate washing of the vehicle. Further, the inverted U-shaped frame, in an instance, may be configured to support the multiple components and/or may be configured to maintain structural integrity associated with the personal collapsible auto vehicle washing apparatus. Further, the inverted U-shaped frame, in an instance, may include vertical leg bars and horizontal head bars. Further, the vertical leg bar may have two ends such as an upper end and a lower end. The lower end of the vertical leg bar, in an instance, may be connected with wheels that may allow the personal collapsible auto vehicle washing apparatus to move forward and/or backward. Whereas, the upper end of the vertical leg bar, in an instance, may be connected to one of two sides of the horizontal head bar. In an instance, the inverted U-shaped frame may include two vertical leg bars that may be positioned parallel to each other with the lower end (with the wheels) to be in contact with a floor (where the said apparatus may be positioned) and one horizontal head bar that may be connected with the upper end of each of the two vertical leg bars forming an inverted U-shaped frame. Further, the inverted U-shaped frame, in an instance, may provide a vehicle passageway for the vehicle that may need to be washed. Further, the vehicle passageway, in an instance, may be a driveway for the vehicle through which the vehicle may enter/exit the personal collapsible auto vehicle washing apparatus.

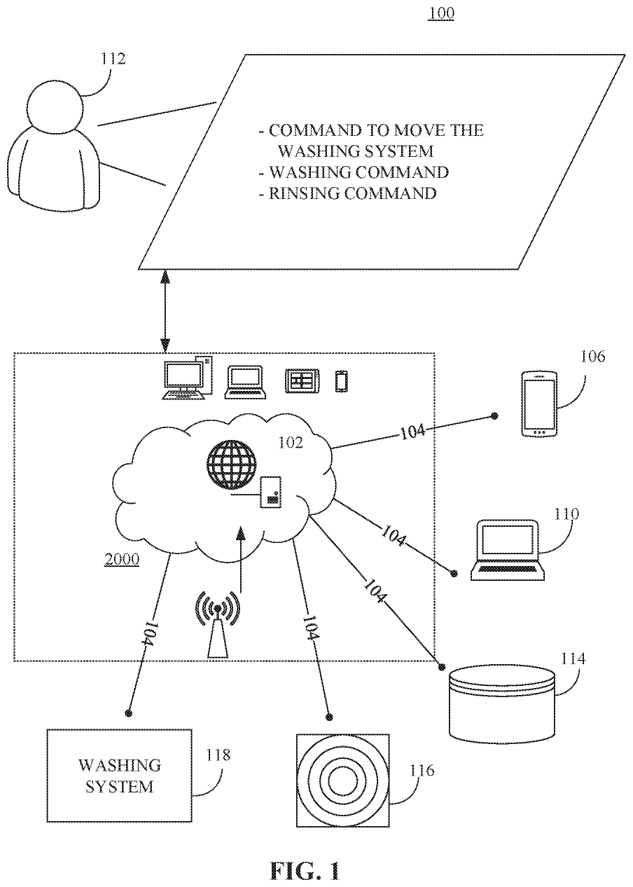

Further, the upper end of the vertical leg bar, in an instance, may be configured to be raised and/or lowered in order to adjust a height associated with the vehicle passageway based on dimensions of the vehicle. Further, the personal collapsible auto vehicle washing apparatus, in an instance, may include one or more of sensors (such as sensors 116 shown in FIG. 1 below) that may be configured to sense the dimensions associated with the vehicle. The one or more sensors, in an instance, may include sensors such as (but not limited to) ultrasonic sensors, proximity sensors etc.

Further, the inverted U-shaped frame, in an instance, may be configured to support tubes (and/or hoses) through which one or more of fluids (such as water, soap solution, detergent, and/or other car washing fluid) may flow. Further, the inverted U-shaped frame, in an instance, may include a plurality of dispensers. Further, each dispenser of the plurality of dispensers, in an instance, may be configured to spray the one or more fluids towards the vehicle passageway. Further, the plurality of dispensers, in an instance, may be embedded and/or disposed at the vertical leg bars and/or the horizontal head bars of the personal collapsible auto vehicle washing apparatus. In an instance, the plurality of dispensers may include one or more soap dispensers and water dispensers. The water dispensers, in an instance, may be configured to dispense clean water with an appropriate pressure towards the vehicle passageway. Further, the clean water, in an instance, may be taken from a water source. The water source, in an instance, may be a container that may be configured to store the clean water that may be used by the personal collapsible auto vehicle washing apparatus in order to wash the vehicle. Further, the water source, in an instance, may be connected with the personal collapsible auto vehicle washing apparatus through a water connector. Further, the water connector, in an instance, may be a hose connector that may allow the clean water to flow from the water source to the water dispenser at an appropriate pressure. Similarly, the soap dispensers, in an instance, may be configured to dispense a soapy fluid (such as a detergent for a car wash) with an appropriate pressure towards the vehicle passageway. Further, the soapy fluid, in an instance, may be taken from a fluid source. The fluid source, in an instance, may be a container that may be configured to store the soapy fluid that may be used by the personal collapsible auto vehicle washing apparatus in order to wash the vehicle. Further, the fluid source, in an instance, may be connected with the personal collapsible auto vehicle washing apparatus through a soap connector. Further, the soap connector, in an instance, may be a hose connector that may allow the soapy fluid to flow from the fluid source to the soap dispenser at an appropriate pressure.

Further, the personal collapsible auto vehicle washing apparatus, in an instance, may include a plurality of brushes. Further, each brush of the plurality of brushes, in an instance, may comprise of a rotating mechanism (such as a motor) that may allow the brushes to rotate about its longitudinal axis. Further, each brush of the plurality of brushes, in an instance, may be made up of flexible bristles which may be simultaneously thrown outwardly into a cylindrical configuration as the brush rotates about its longitudinal axis. Further, the flexible bristles, in an instance, may be made up of materials such as (but not limited to) nylon (e.g., soft nylon), soft fiber, microfiber, foam, bristle combination (e.g., nylon and wire for wheels and tires), etc.

In an instance, the plurality of brushes may include two or more leg brushes and head brushes. Further, the leg brushes, in an instance, may be placed along with the vertical leg bars of the inverted U-shaped frame in a way such that a longitudinal axis of the leg brush (i.e., an axis along which the leg brush rotates) may be parallel to an axis of the vertical leg bar. Further, the leg brushes, in an instance, may be configured to revolve and/or swing around the vertical leg bar in order to vary width of the vehicle passageway based on the dimensions of the vehicle (and/or curves on a surface of the vehicle). Similarly, the head brushes, in an instance, may be placed along with the horizontal head bars of the inverted U-shaped frame in a way such that a longitudinal axis of the head brush (i.e., an axis along which the head brush rotates) may be parallel to an axis of the horizontal head bar. Further, the head brushes, in an instance, may be configured to revolve and/or swing around the horizontal head bar in order to vary height of the vehicle passageway based on the dimensions of the vehicle (and/or curves on a surface of the vehicle).

Further, the personal collapsible auto vehicle washing apparatus, in an instance, may include a collapsible mechanism that may allow the personal collapsible auto vehicle washing apparatus to fold into half when not in use. For instance, the collapsible mechanism may include (but not limited to) hinges that may be placed proximal to the horizontal head bar, allowing the personal collapsible auto vehicle washing apparatus to fold into half in order to enhance portability.

Further, in some embodiments, the personal collapsible auto vehicle washing apparatus may include a power source that may be configured to provide necessary electrical power required by for operation of multiple components such as the one or more sensors, actuators, and/or motors, etc. Further, in one embodiment, the power source may include a battery that may need to be charged prior to use. Further, the battery, in an instance, may be charged from (but not limited to) AC mains outlet, solar panels, etc.

Further, in some embodiments, the personal collapsible auto vehicle washing apparatus may be configured to communicate with the online platform through a communication device. Further, the online platform, in an instance, may be configured to receive data from the personal collapsible auto vehicle washing apparatus (through the communication device). The data, in an instance, may include (but not limited to) information such as brush rotating speed, height of the vehicle passageway, width of the vehicle passageway, an amount of clean water dispensed through the water dispenser, an amount of soapy fluid dispensed through the soap dispenser, and so on.

Further, the online platform, in some embodiments, may be configured to transmit an appropriate actuating signal to the personal collapsible auto vehicle washing apparatus based on the data received. Accordingly, the appropriate actuating signal may include, but is not limited to, moving horizontal head bars up/down for increasing/decreasing the vehicle passageway, moving the personal collapsible auto vehicle washing apparatus forward/backward, actuating the water dispenser, folding the personal collapsible auto vehicle washing apparatus, etc.

Further, in some embodiments, a user may be able to communicate with the personal collapsible auto vehicle washing apparatus through a user device (such as a mobile device 106 or an electronic device in the other electronic devices 110 shown in FIG. 1 below). Accordingly, the user device, in an instance, may be any IoT based device that may be configured to communicate with the online platform. Further, the user device, in an instance, may include devices such as (but not limited to) smartphones, smartwatches, PCs, laptops, tablets, etc.

Further, a user (such as a person that may wish to clean a vehicle), in an instance, may drive the vehicle (such as a car) towards the vehicle passageway associated with the personal collapsible auto vehicle washing apparatus. Further, the horizontal head bar of the personal collapsible auto vehicle washing apparatus, in an instance, may be lowered in a way such that the head brushes provide a constant pressure over a surface of the vehicle as they (the head brushes) rotate for washing the surface. Further, the plurality of dispensers (such as the water dispenser and the soap dispenser), in an instance, may be activated in order to spray the one or more fluids towards the vehicle passageway. Further, as the user may drive through the vehicle passageway, a height associated with the vehicle passageway may be increased based on the dimension (and/or height) of the vehicle. The one or more of sensors (such as, but not limited to, ultrasonic sensors, proximity sensors, etc.) may be configured to sense the dimensions associated with the vehicle. Accordingly, sensor data from the one or more sensors, in an instance, may be analyzed by the online platform in order to determine the appropriate actuating signal that may need to be transmitted to the personal collapsible auto vehicle washing apparatus. For instance, the appropriate actuating signal may include a pulse signal that may actuate a motor in order to raise the horizontal head bar upward. Similarly, a height associated with the vehicle passageway may be decreased based on the dimension (and/or height) of the vehicle. Further, once the vehicle may completely pass through the vehicle passageway the personal collapsible auto vehicle washing apparatus may fold into half with the collapsible mechanism.

Further, in some embodiments, the personal collapsible auto vehicle washing apparatus may move towards the vehicle that may need to be washed instead of the vehicle moving towards the vehicle passageway.

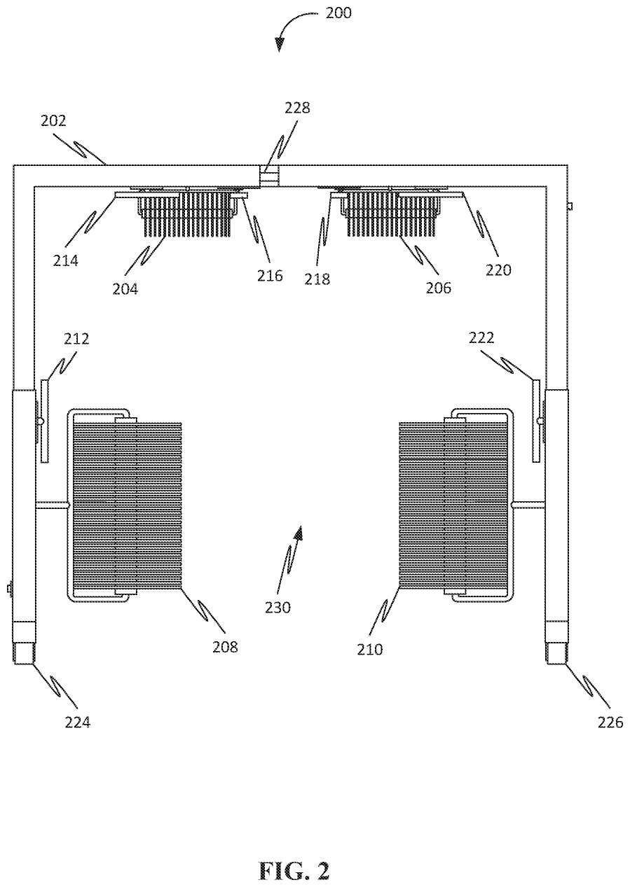

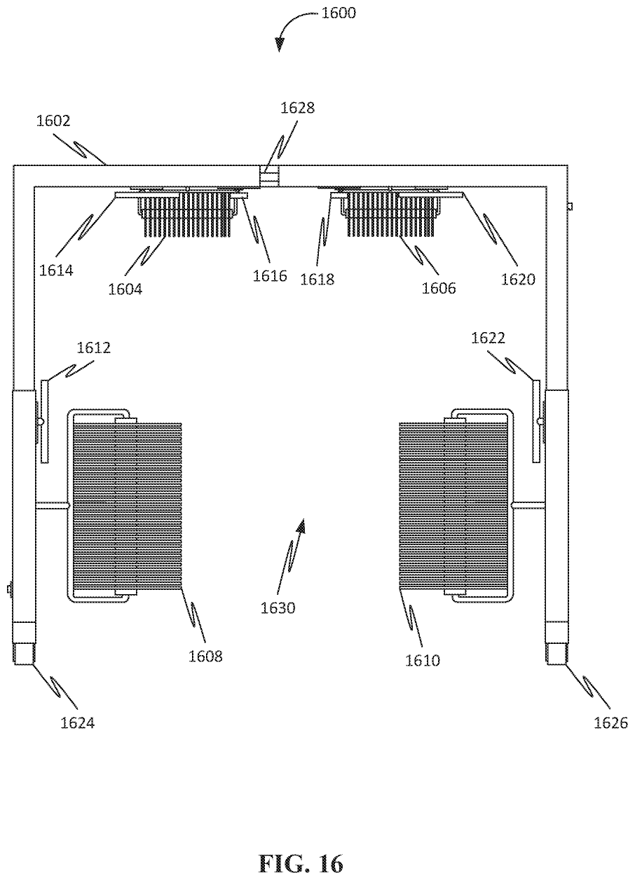

Referring now to figures, FIG. 1 is an illustration of an online platform 100 consistent with various embodiments of the present disclosure. By way of non-limiting example, the online platform 100 to facilitate operation of a washing system 118 may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116 (such as at least one object sensor, at least one cleaning agent sensor, at least one brush sensor, ultrasonic sensor and proximity sensor) over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform. The washing system 118 may include at least one of a washing system 200 and a washing system 1600 described in detail in conjunction with FIGS. 2 and 16 below, respectively.

A user 112, such as the one or more relevant parties, may access online platform 100 through a web-based software application or browser. The web-based software application may be embodied as, for example, but not be limited to, a website, a web application, a desktop application, and a mobile application compatible with a computing device 2000.

FIG. 2 is a front view of the washing system 200, in accordance with some embodiments. Accordingly, the washing system 200 may include a frame 202, at least one brush 204-210, at least one cleaning agent dispenser 212-222, a plurality of wheels 224-226, at least one actuator (not shown), a power source (not shown), and a controller (not shown).

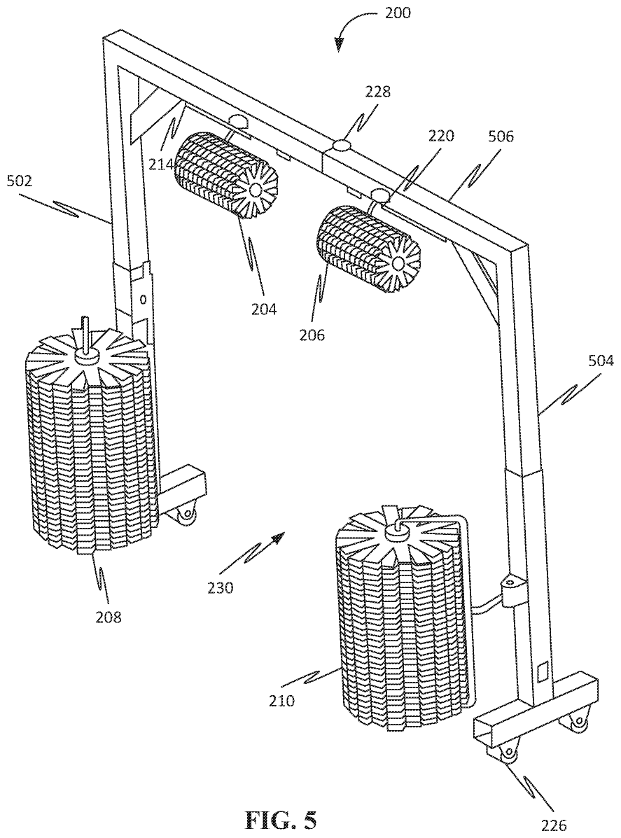

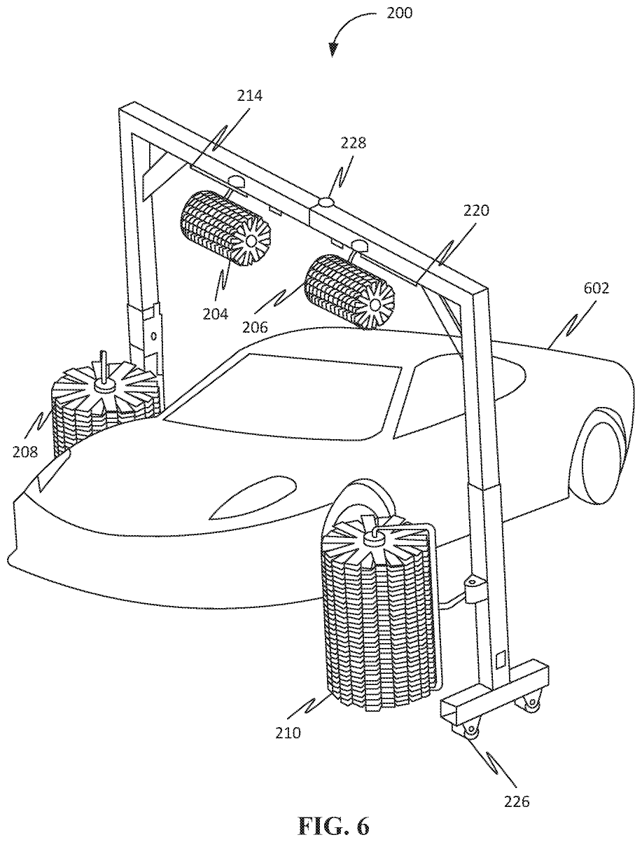

Further, the frame 202 may be configured to be arranged in a plurality of frame configurations. Further, at least one operational frame configuration of the plurality of frame configurations may include a passageway 230. Further, the passageway 230 may be configured to partly encompass at least one object. In an instance, the plurality of frame configurations may include an inverted U-shaped frame configuration. In an instance, the inverted U-shaped frame configuration may provide a passageway 230 for a vehicle 602, as shown in FIG. 6. Further, the inverted U-shaped frame configuration, in an instance, may be configured to support the multiple components and/or may be configured to maintain structural integrity associated with the washing system 200. Further, the inverted U-shaped frame configuration, in an instance, may include vertical leg bars 502-504 and horizontal head bar 506, as shown in FIG. 5. Further, the vertical leg bars 502-504 may have two ends such as an upper end and a lower end. Further, the upper end of the vertical leg bars 502-504, in an instance, may be connected to one of the two sides of the horizontal head bar 506. In an instance, the inverted U-shaped frame configuration may include vertical leg bars 502-504 and a horizontal head bar 506. Further, the vertical leg bars 502-504 may be positioned parallel to each other with the lower end (with the plurality of wheels 224-226) to be in contact with a floor. Further, the horizontal head bar 506 that may be connected with the upper end of each of the vertical leg bars 502-504 forming an inverted U-shaped frame configuration.

Further, the at least one brush 204-210 may be coupled to the frame 202. Further, the at least one brush 204-210 may be configured to perform at least one brushing action on the at least one object. Further, each brush of the at least one brush 204-210, in an instance, may include a rotating mechanism (such as a motor) that may allow the brushes to rotate about its longitudinal axis. Further, each brush of the at least one brush 204-210, in an instance, may be made up of flexible bristles which may be simultaneously thrown outwardly into a cylindrical configuration as the brush rotates about its longitudinal axis. Further, the flexible bristles, in an instance, may be made up of materials such as (but not limited to) nylon (e.g., soft nylon), soft fiber, microfiber, foam, bristle combination (e.g., nylon and wire for wheels and tires), etc.

In an instance, the at least one brush 204-210 may include leg brushes 208-210, and head brushes 204-206. Further, the leg brushes 208-210, in an instance, may be placed along with the vertical leg bars 502-504 of the inverted U-shaped frame configuration respectively. Further, longitudinal axes of the leg brushes 208-210 (i.e., an axis along which the leg brush rotates) may be parallel to an axis of the vertical leg bars 502-504 respectively. Further, the leg brushes 208-210, in an instance, may be configured to revolve and/or swing around the vertical leg bar 502-504 in order to vary width of the passageway 230 based on the dimensions of the vehicle 602 (and/or curves on a surface of the vehicle 602). Similarly, the head brushes 204-206, in an instance, may be placed along with the horizontal head bar 506 of the inverted U-shaped frame configuration in a way such that a longitudinal axis of the head brushes 204-206 (i.e., an axis along which the head brush rotates) may be parallel to an axis of the horizontal head bar 506.

Further, the at least one cleaning agent dispenser 212-222 mounted on the frame 202. Further, the at least one cleaning agent dispenser 212-222 may be configured to perform at least one cleaning agent dispensing action. Further, the at least one cleaning agent dispenser 212-222, in an instance, may be configured to spray the one or more fluids towards the passageway 230. Further, the at least one cleaning agent dispenser 212-222, in an instance, may be embedded and/or disposed at the vertical leg bars 502-504 and/or the horizontal head bar 506 of the washing system 200.

In an instance, the at least one cleaning agent dispenser 212-222 may include at least one water dispenser 212, 214, 220 and 222, and at least one detergent dispenser 216-218. Further, the at least one water dispenser 212, 214, 220 and 222, in an instance, may be configured to dispense clean water with an appropriate pressure towards the passageway 230. Further, the clean water, in an instance, may be taken from a water source. Further, the water source, in an instance, may be a container that may be configured to store the clean water that may be used by the washing system 200 in order to wash the vehicle 602. Further, the water source, in an instance, may be connected with the washing system 200 through a water connector.

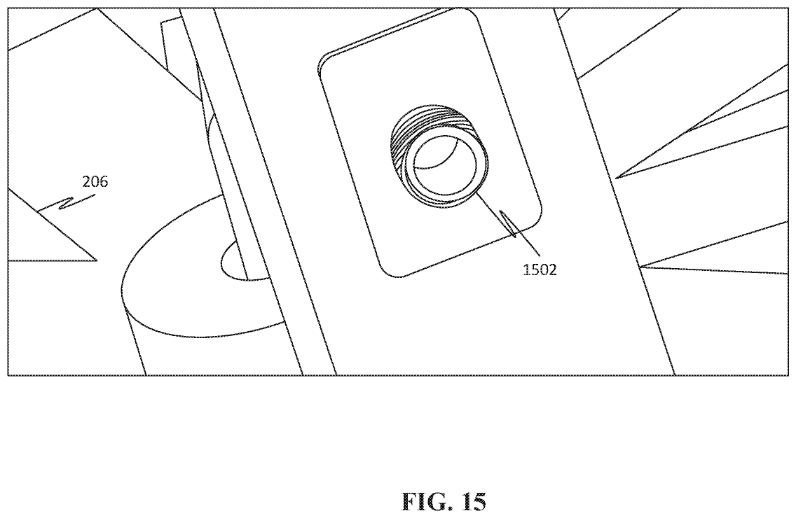

Similarly, the at least one detergent dispenser 216-218, in an instance, may be configured to dispense a soapy fluid (such as a detergent for a car wash) with an appropriate pressure towards the passageway 230. Further, the soapy fluid, in an instance, may be taken from a fluid source. Further, the fluid source, in an instance, may be a container that may be configured to store the soapy fluid that may be used by the washing system 200 in order to wash the vehicle 602. Further, the fluid source, in an instance, may be connected with the washing system 200 through a soap connector. Further, the at least one cleaning agent dispenser 212-222 may include at least one inlet port 1502, as shown in FIG. 15, and at least one outlet port (not shown). Further, the at least one inlet port 1502 and the at least one outlet port may be fluidly coupled. Further, the at least one inlet port 1502 may be configured to receive at least one cleaning agent. Further, the at least one outlet port may be configured to dispense the at least one cleaning agent.

Further, the plurality of wheels 224-226 may be mounted on the frame 202. Further, the plurality of wheels 224-226 may be configured to facilitate the movement of the frame 202 on a surface in at least one direction.

Further, the at least one actuator may be operationally coupled with the at least one wheel. Further, the at least one actuator may be configured to perform at least one actuator operation. Further, the at least one actuator operation may include rotating the at least one wheel.

Further, in some embodiments, the at least one actuator may be operationally coupled with the at least one cleaning agent dispenser 212-222. Further, the at least one actuator operation may include performing the at least one cleaning agent dispensing action. Further, the washing system 200 may include the at least one cleaning agent sensor (not shown) mounted on the frame 202. Further, the at least one cleaning agent sensor may be communicatively coupled with the controller. Further, the at least one cleaning agent sensor may be configured to generate at least one cleaning agent sensor data corresponding to the at least one object. Further, the controller may be configured to control the at least one actuator based on the at least one cleaning agent sensor data.

Further, the power source electrically coupled with the at least one actuator. Further, the power source may be configured to provide electrical power to the at least one actuator. Further, in one embodiment, the power source may include a battery that may need to be charged prior to use. Further, the battery, in an instance, may be charged from (but not limited to) AC mains outlet, solar panel, etc.

Further, the controller communicatively coupled with the at least one actuator. Further, the controller may be configured to control the at least one actuator.

Further, in some embodiments, the frame 202 may include at least one arranging mechanism (not shown). Further, the at least one arranging mechanism facilitates arranging the frame 202 in the plurality of frame configurations. Further, the plurality of frame configurations may include a collapsed frame configuration and the at least one operational frame configuration. Further, the collapsed frame configuration may not include the passageway 230. Further, the collapsed frame configuration, in an instance, may include a collapsible mechanism that may allow the collapsed frame configuration to fold into half when not in use. For instance, the collapsible mechanism may include (but not limited to) hinges 228 that may be placed proximal to the horizontal head bar, allowing the collapsed frame configuration to fold into half in order to enhance portability. Further, the at least one actuator may be operationally coupled with a collapsing mechanism of the at least one arranging mechanism. Further, the at least one actuator operation may include transitioning the frame 202 between the collapsed frame configuration and the at least one operational frame configuration. Further, the washing system 200 may include at least one input device communicatively coupled with the controller over at least one of a wired communication channel and a wireless communication channel. Further, the at least one input device may be configured to receive at least one input command associated with the plurality of frame configurations. Further, the controller may be configured to control the at least one actuator based on the at least one input command.

Further, the at least one actuator may be operationally coupled with the at least one arranging mechanism. Further, the at least one actuator operation may include arranging the frame 202 in the at least one operational frame configuration. Further, the washing system 200 may include the at least one object sensor (not shown) mounted on the frame 202. Further, the at least one object sensor may be communicatively coupled with the controller. Further, the at least one object sensor may be configured to generate at least one object sensor data corresponding the at least one object. Further, the controller may be configured to control the at least one actuator based on the at least one object sensor data.

Further, in some embodiments, the at least one object may be associated with at least one object configuration. Further, the frame 202 may be configured to move through a plurality of object positions in relation to the at least one object. Further, the plurality of object positions corresponds to a plurality of object shapes. Further, the at least one object configuration may be associated with an object shape of the plurality of object shapes corresponding an object position of the plurality of object positions. Further, the frame 202 may be configured to be arranged in the at least one operational frame configuration according to the at least one object configuration.

Further, in some embodiments, the at least one cleaning agent dispenser 212-222 may include at least one detergent dispenser 216-218 and at least one water dispenser 212, 214, 220 and 222. Further, the at least one detergent dispenser 216-218 may be configured to dispense at least one detergent and at least one water dispenser 212, 214, 220 and 222 may be configured to dispense water.

Further, in some embodiments, the at least one cleaning agent dispenser 212-222 may be configured to dispense at least one detergent and water.

Further, in some embodiments, the at least one inlet port 1502 may be fluidly coupled with at least one external cleaning agent source. Further, the at least one inlet port 1502 may be configured to receive the at least one cleaning agent from the at least one external cleaning agent source. Further, the at least one outlet port may be configured to dispense the at least one cleaning agent.

Further, in some embodiments, the at least one inlet port 1502 may be fluidly coupled with at least one cleaning agent cartridge. Further, the at least one cleaning agent cartridge may be detachably disposed in the frame 202. Further, the at least one cleaning agent cartridge may include at least one container configured to store the at least one cleaning agent. Further, the at least one inlet may be configured to receive the at least one cleaning agent from the at least one cleaning agent cartridge. Further, the at least one outlet port may be configured to dispense the at least one cleaning agent.

Further, in some embodiments, the at least one brush 204-210 may be movably coupled to the frame 202 using at least one brush-movement mechanism. Further, the at least one brush-movement mechanism may be configured to provide at least one brush movement to the at least one brush 204-210. Further, the at least one brush movement may facilitate the at least one brushing action on the at least one object. Further, the at least one actuator may be operationally coupled with the at least one brush-movement mechanism and the at least one brush 204-210. Further, the at least one actuator operation may include providing the at least one brush movement to the at least one brush 204-210. Further, the at least one actuator operation may include performing the at least one brushing action.

Further, the washing system 200 may include the at least one brush sensor mounted on the frame 202. Further, the at least one brush sensor may be communicatively coupled with the controller. Further, the at least one brush sensor may be configured to generate at least one brush sensor data corresponding to the at least one object. Further, the controller may be configured to control the at least one actuator based on the at least one brush sensor data.

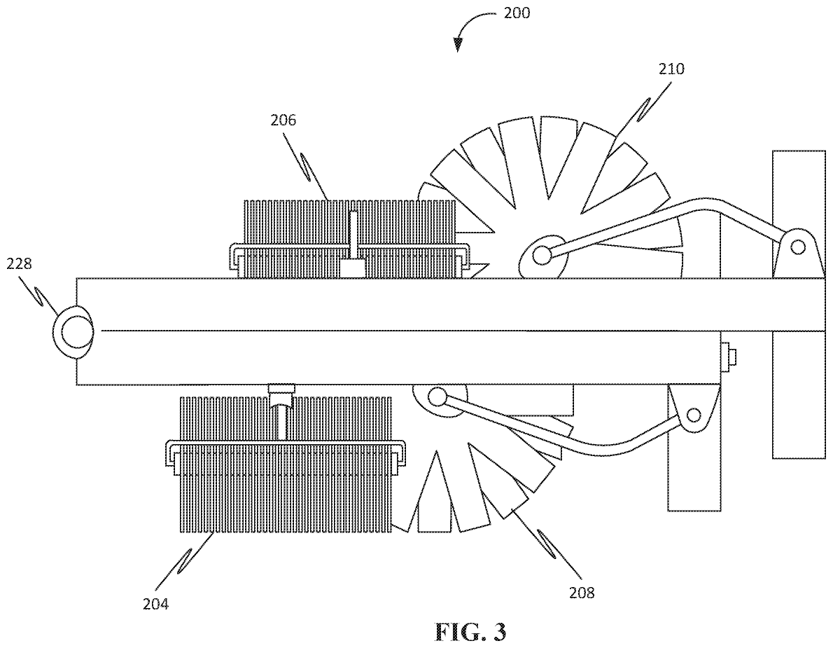

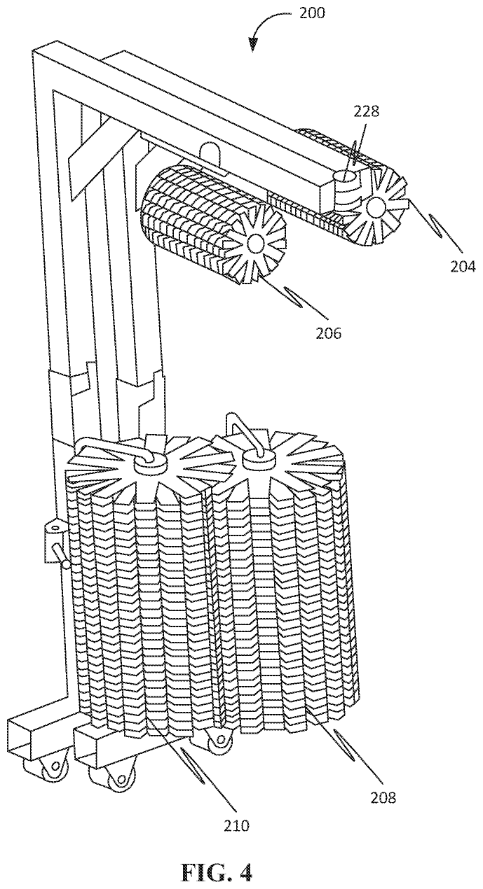

FIG. 3 is a top view of the washing system 200 when the washing system 200 is folded into half using the collapsing mechanism, in accordance with some embodiments. FIG. 4 is a perspective view of the washing system 200 when the washing system 200 is folded into half using the collapsing mechanism, in accordance with some embodiments. FIG. 5 is a perspective view of the washing system 200, in accordance with some embodiments.

FIG. 6 is a perspective view of the washing system 200 with a vehicle 602 entering the passageway 230, in accordance with some embodiments. Further, the passageway 230 may be configured to partly encompass at least one object. Further, the passageway 230, in an instance, may be a driveway for the vehicle 602 through which the vehicle 602 may enter/exit the washing system 200. Further, as shown in FIG. 5, the upper end of the vertical leg bar 506, in an instance, may be configured to be raised and/or lowered in order to adjust a height associated with the passageway 230 based on dimensions of the vehicle 602. Further, the washing system 200, in an instance, may include one or more of sensors that may be configured to sense the dimensions associated with the vehicle 602. Further, the one or more sensors, in an instance, may include sensors such as (but not limited to) ultrasonic sensors, proximity sensors, etc.

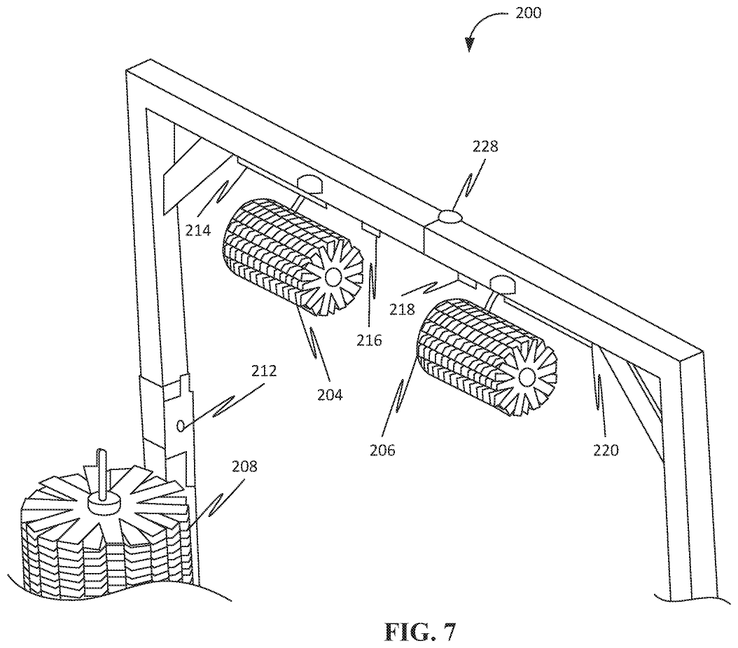

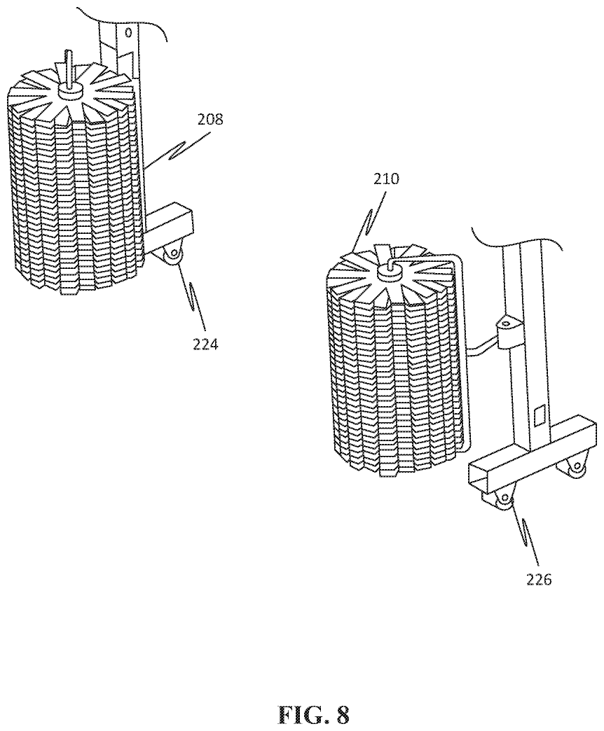

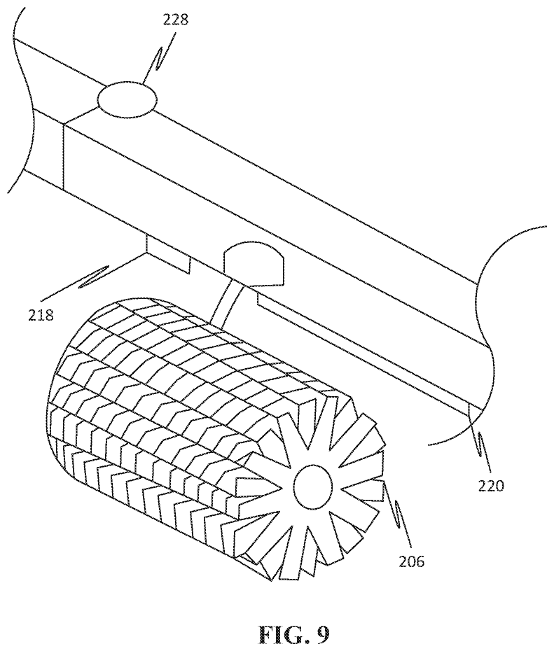

FIG. 7 is a partial view of the washing system 200, in accordance with some embodiments. FIG. 8 is a partial view of leg brushes of the washing system 200, in accordance with some embodiments. FIG. 9 is a partial view of a horizontal head bar 506 of the washing system 200, in accordance with some embodiments. Further, the horizontal head bar 506 may include a head brush 206 and a collapsible mechanism.

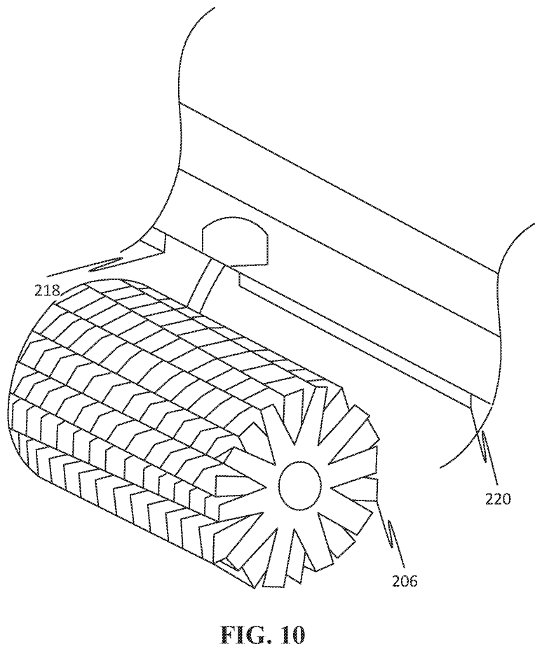

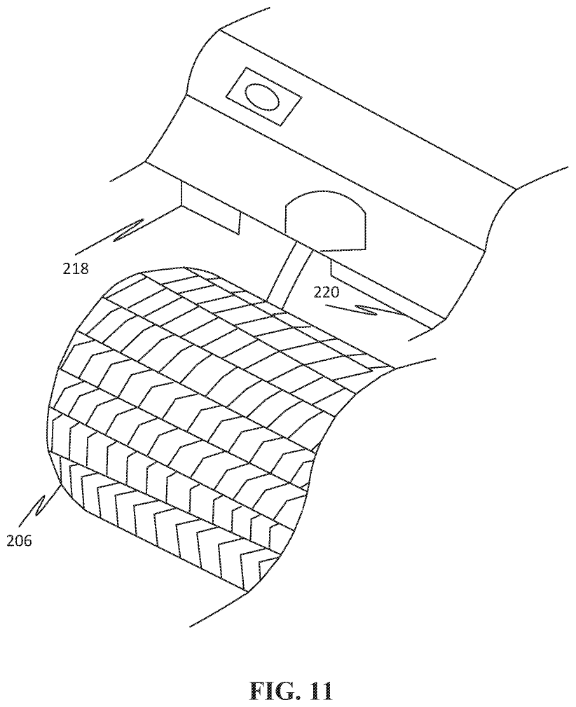

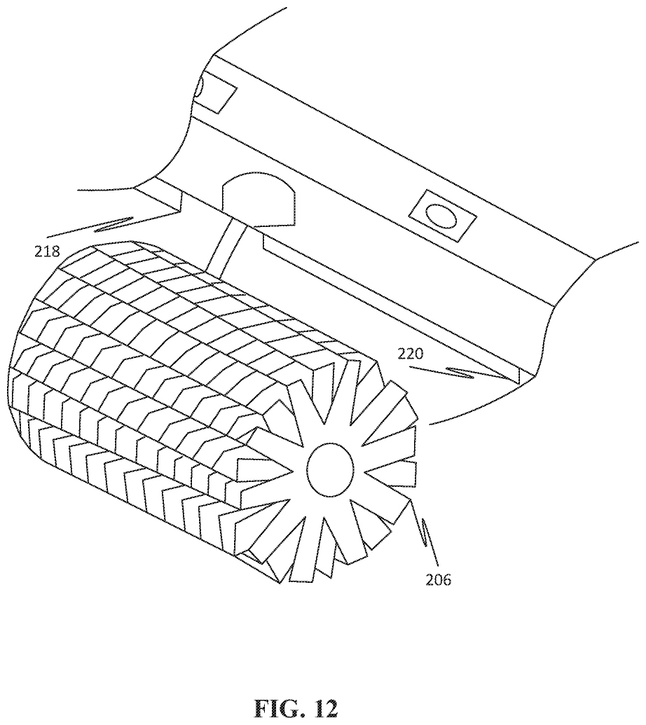

FIG. 10 is a partial view of a horizontal head bar 506 of the washing system 200, in accordance with some embodiments. FIG. 11 is a partial view of a horizontal head bar 506 of the washing system 200 with at least one detergent dispenser 216-218, in accordance with some embodiments. FIG. 12 is a partial view of a horizontal head bar 506 of the washing system 200 with at least one water dispenser 212, 214, 220 and 222, in accordance with some embodiments.

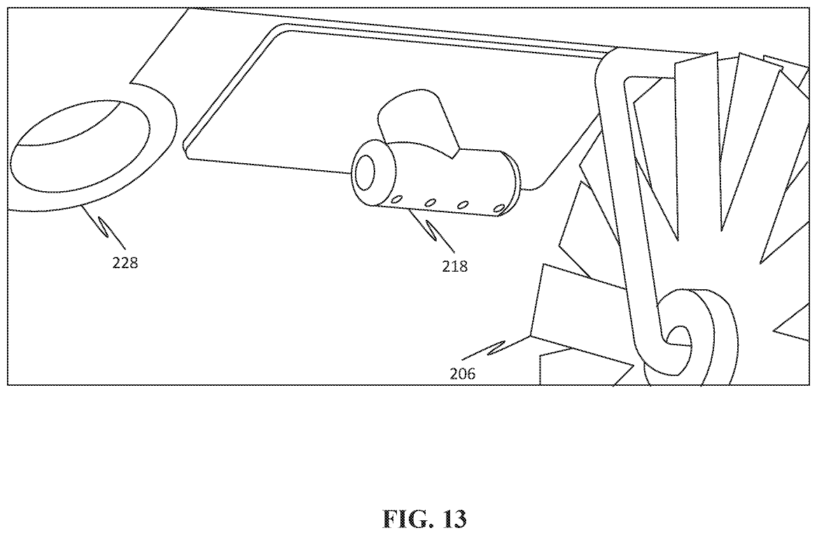

FIG. 13 is a close-up view of the washing system 200 with at least one detergent dispenser 216-218, in accordance with some embodiments. Further, the at least one detergent dispenser 216-218, in an instance, may be configured to dispense a soapy fluid (such as a detergent for a car wash) with an appropriate pressure towards the passageway 230. Further, the soapy fluid, in an instance, may be taken from a fluid source. Further, the fluid source, in an instance, may be a container that may be configured to store the soapy fluid that may be used by the washing system 200 in order to wash the vehicle 602. Further, the fluid source, in an instance, may be connected with the washing system 200 through a soap connector. Further, the soap connector, in an instance, may be a hose connector that may allow the soapy fluid to flow from the fluid source to the at least one detergent dispenser 216-218 at an appropriate pressure.

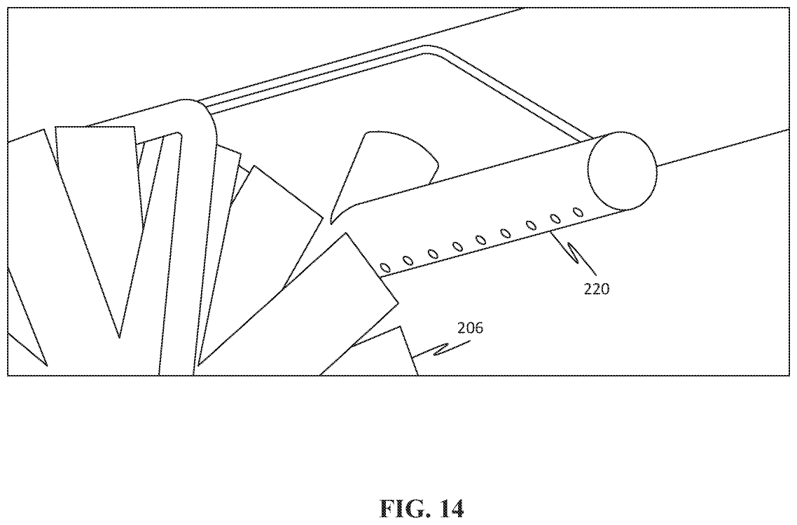

FIG. 14 is a close-up view of the washing system 200 with at least one water dispenser 212, 214, 220 and 222, in accordance with some embodiments. Further, the at least one water dispenser 212, 214, 220 and 222, in an instance, may be configured to dispense clean water with an appropriate pressure towards the passageway 230. Further, the clean water, in an instance, may be taken from a water source. Further, the water source, in an instance, may be a container that may be configured to store the clean water that may be used by the washing system 200 in order to wash the vehicle 602. Further, the water source, in an instance, may be connected with the washing system 200 through a water connector. Further, the water connector, in an instance, may be a hose connector that may allow the clean water to flow from the water source to the water dispenser at an appropriate pressure.

FIG. 15 is a close-up view of the washing system 200 with at least one inlet port 1502, in accordance with some embodiments.

FIG. 16 is a front view of the washing system 1600, in accordance with some embodiments. Accordingly, the washing system 1600 may include a frame 1602, at least one brush 1604-1610, at least one cleaning agent dispenser 1612-1622, a plurality of wheels 1624-1626, at least one actuator (not shown), a power source (not shown) and a controller (not shown).

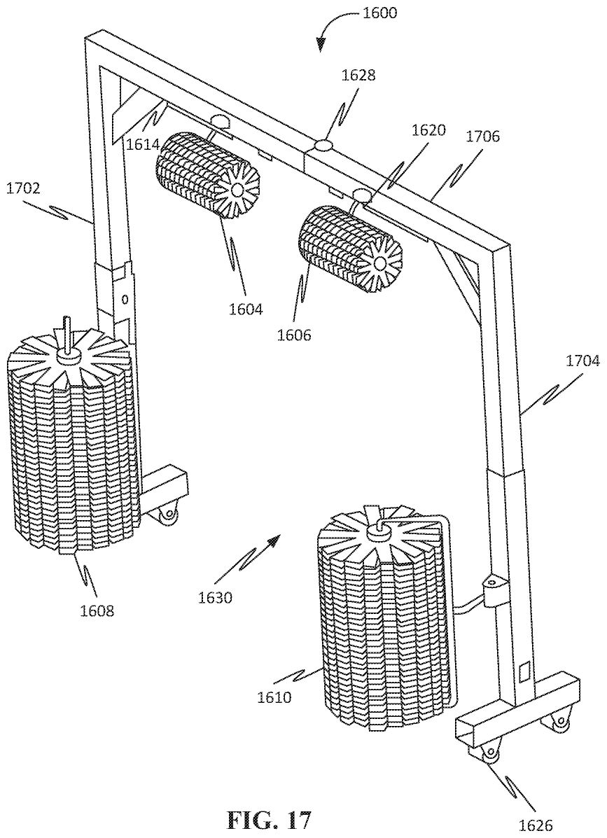

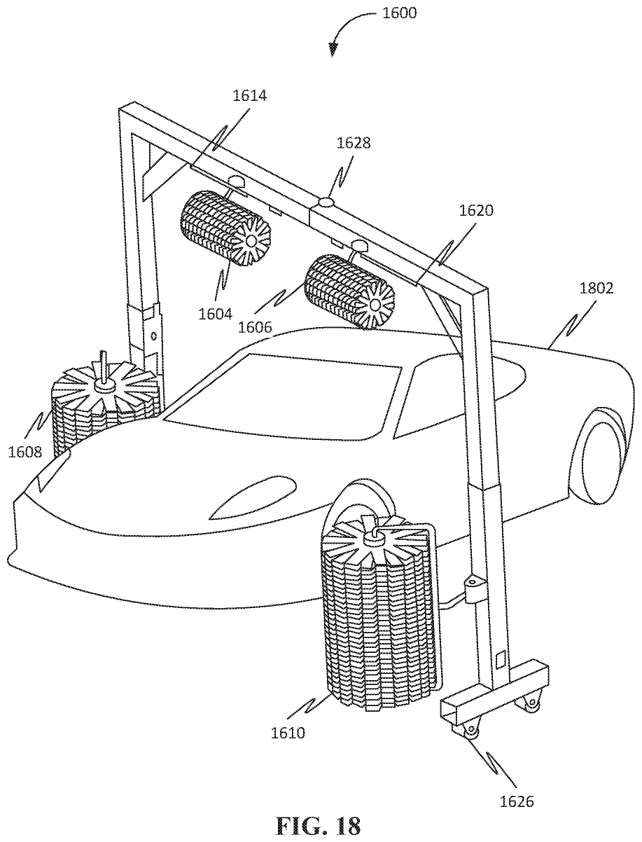

Further, the frame 1602 may be configured to be arranged in a plurality of frame configurations. Further, at least one operational frame configuration of the plurality of frame configurations may include a passageway 1630. Further, the passageway 1630 may be configured to partly encompass at least one object. In an instance, the plurality of frame configuration may include an inverted U-shaped frame configuration. In an instance, the inverted U-shaped frame configuration may provide the passageway 1630 for the vehicle 1802, as shown in FIG. 18. Further, the inverted U-shaped frame configuration, in an instance, may be configured to support the multiple components and/or may be configured to maintain structural integrity associated with the washing system 1600. Further, the inverted U-shaped frame configuration, in an instance, may include vertical leg bars 1702-1704 and horizontal head bar 1706 as shown in FIG. 17. Further, the vertical leg bars 1702-1704 may have two ends such as an upper end and a lower end. Further, the upper end of the vertical leg bars 1702-1704, in an instance, may be connected to one of two sides of the horizontal head bar 1706. In an instance, the inverted U-shaped frame configuration may include vertical leg bars 1702-1704 that may be positioned parallel to each other with the lower end (with the plurality of wheels 1624-1626) to be in contact with a floor and horizontal head bar 1706 that may be connected with the upper end of each of the vertical leg bars 1702-1704 forming an inverted U-shaped frame configuration.

Further, the at least one brush 1604-1610 may be movably coupled to the frame 1602 using at least one brush-movement mechanism. Further, the at least one brush 1604-1610 may be configured to perform at least one brushing action on the at least one object. Further, the at least one brush-movement mechanism may be configured to provide at least one brush movement to the at least one brush 1604-1610. Further, the at least one brush movement may facilitate the at least one brushing action. Further, each brush of the at least one brush 1604-1610, in an instance, may include a rotating mechanism (such as a motor) that may allow the brushes to rotate about its longitudinal axis. Further, each brush of the at least one brush 1604-1610, in an instance, may be made up of flexible bristles which may be simultaneously thrown outwardly into a cylindrical configuration as the brush rotates about its longitudinal axis. Further, the flexible bristles, in an instance, may be made up of materials such as (but not limited to) nylon (e.g., soft nylon), soft fiber, microfiber, foam, bristle combination (e.g., nylon and wire for wheels and tires), etc.

In an instance, the at least one brush 1604-1610 may include leg brushes 1608-1610, and head brushes 1604-1606. Further, the leg brushes 1608-1610, in an instance, may be placed along with the vertical leg bars 1702-1704 of the inverted U-shaped frame configuration in a way such that a longitudinal axis of the leg brushes 1608-1610 (i.e., an axis along which the leg brush rotates) may be parallel to an axis of the vertical leg bars 1702-1704. Further, the leg brushes 1608-1610, in an instance, may be configured to revolve and/or swing around the vertical leg bar 1702-1704 in order to vary width of the passageway 1630 based on the dimensions of the vehicle 1802 (and/or curves on a surface of the vehicle 1802). Similarly, the head brushes 1604-1606, in an instance, may be placed along with the horizontal head bar 1706 of the inverted U-shaped frame configuration in a way such that a longitudinal axis of the head brushes 1604-1606 (i.e., an axis along which the head brush rotates) may be parallel to an axis of the horizontal head bar 1706.

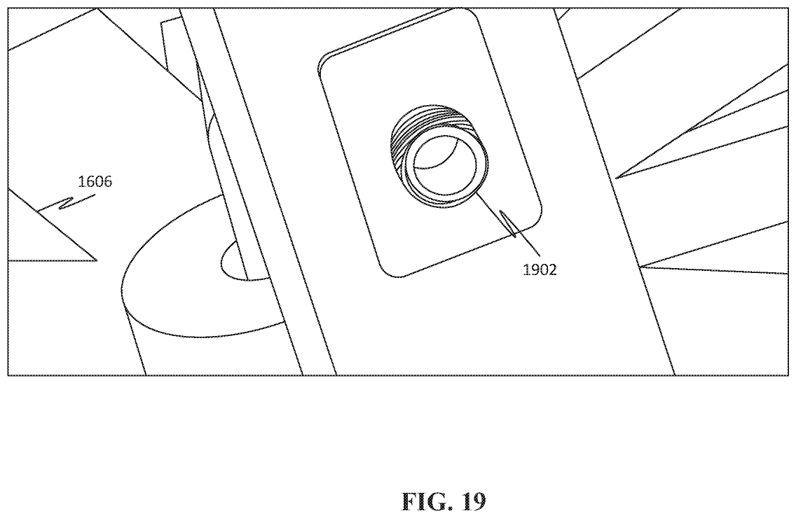

Further, the at least one cleaning agent dispenser 1612-1622 mounted on the frame 1602. Further, the at least one cleaning agent dispenser 1612-1622 may be configured to perform at least one cleaning agent dispensing action. Further, the at least one inlet port 1902, as shown in FIG. 19 and the at least one outlet port (not shown) may be fluidly coupled. Further, the at least one inlet port 1902 may be configured to receive at least one cleaning agent. Further, the at least one outlet port may be configured to dispense the at least one cleaning agent. Further, the at least one cleaning agent dispenser 1612-1622, in an instance, may be configured to spray the one or more fluids towards the passageway 1630. Further, the at least one cleaning agent dispenser 1612-1622, in an instance, may be embedded and/or disposed at the vertical leg bars 1702-1704 and/or the horizontal head bar 1706 of the washing system 1600.

In an instance, the at least one cleaning agent dispenser 1612-1622 may include at least one water dispenser 1612, 1614, 1620 and 1622, and at least one detergent dispenser 1616-1618. Further, the at least one water dispenser 1612, 1614, 1620 and 1622, in an instance, may be configured to dispense clean water with an appropriate pressure towards the passageway 1630. Further, the clean water, in an instance, may be taken from a water source. The water source, in an instance, may be a container that may be configured to store the clean water that may be used by the washing system 1600 in order to wash the vehicle 1802. Further, the water source, in an instance, may be connected with the washing system 1600 through a water connector. Similarly, the at least one detergent dispenser 1616-1618, in an instance, may be configured to dispense a soapy fluid (such as a detergent for a car wash) with an appropriate pressure towards the passageway 1630. Further, the soapy fluid, in an instance, may be taken from a fluid source. The fluid source, in an instance, may be a container that may be configured to store the soapy fluid that may be used by the washing system 1600 in order to wash the vehicle 1802. Further, the fluid source, in an instance, may be connected with the washing system 1600 through a soap connector.

Further, the at least one cleaning agent dispenser 1612-1622 may include at least one inlet port 1902 and at least one outlet port. Further, the at least one inlet port 1902 and the at least one outlet port may be fluidly coupled. Further, the at least one inlet port 1902 may be configured to receive at least one cleaning agent. Further, the at least one outlet port may be configured to dispense the at least one cleaning agent.

Further, the plurality of wheels 1624-1626 mounted on the frame 1602. Further, the plurality of wheels 1624-1626 may be configured to facilitate the movement of the frame 1602 on a surface in at least one direction.

Further, the at least one actuator operationally coupled with the at least one wheel. Further, the at least one actuator may be configured to perform at least one actuator operation. Further, the at least one actuator operation may include rotating the at least one wheel.

Further, the power source electrically coupled with the at least one actuator. Further, the power source may be configured to provide electrical power to the at least one actuator. Further, in one embodiment, the power source may include a battery that may need to be charged prior to use. Further, the battery, in an instance, may be charged from (but not limited to) AC mains outlet, solar panels, etc.

Further, the controller communicatively coupled with the at least one actuator. Further, the controller may be configured to control the at least one actuator.

Further, in some embodiments, the frame 1602 may include at least two leg bars and at least one head bar. Further, a frame configuration of the plurality of frame configurations may include the at least two leg bars positioned parallelly and the at least one head bar positioned perpendicularly in relation to the at least two leg bars.

Further, in some embodiments, the frame 1602 may include a collapsing mechanism. Further, the collapsing mechanism may be configured for arranging the frame 1602 in the plurality of frame configurations. Further, the plurality of frame configurations may include a collapsed frame configuration and the at least one operational frame configuration. Further, the collapsed frame configuration may not include the passageway 1630.

Further, in some embodiments, the at least one object may be associated with at least one object configuration. Further, the frame 1602 may be configured to move through a plurality of object positions in relation to the at least one object. Further, the plurality of object positions corresponds to a plurality of object shapes. Further, the at least one object configuration may be associated with an object shape of the plurality of object shapes corresponding to an object position of the plurality of object positions. Further, the frame 1602 may be configured to be arranged in the at least one operational frame configuration according to the at least one object configuration.

FIG. 17 is a perspective view of the washing system 1600, in accordance with some embodiments. FIG. 18 is a perspective view of the washing system 1600 with a vehicle 1802 entering a passageway 1630, in accordance with some embodiments. FIG. 19 is a close-up view of the washing system 1600 with at least one inlet port 1902, in accordance with some embodiments.

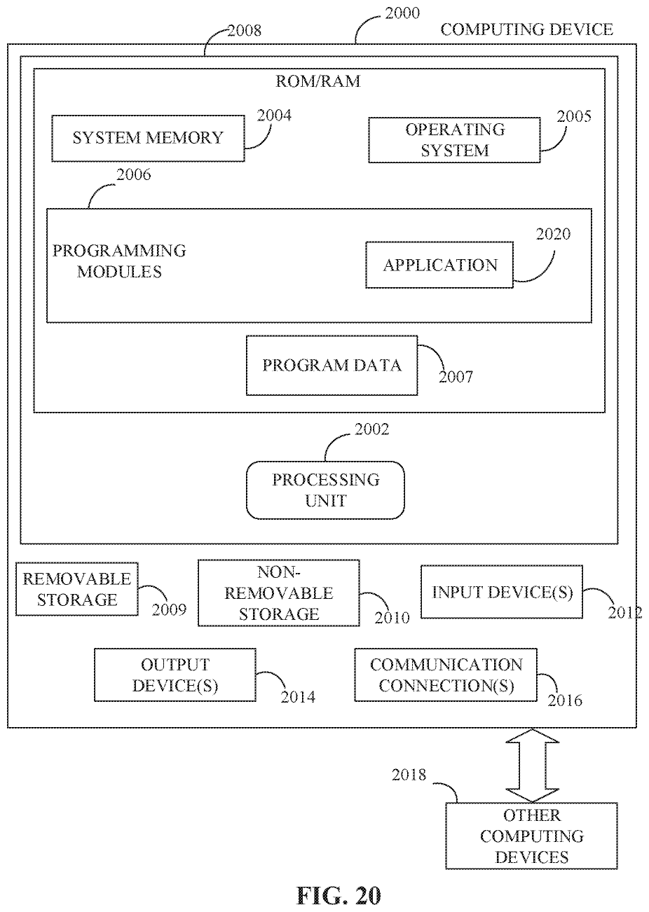

With reference to FIG. 20, a system consistent with an embodiment of the disclosure may include a computing device or cloud service, such as computing device 2000. In a basic configuration, computing device 2000 may include at least one processing unit 2002 and a system memory 2004. Depending on the configuration and type of computing device, system memory 2004 may comprise, but may be not limited to, volatile (e.g. random-access memory (RAM)), non-volatile (e.g. read-only memory (ROM)), flash memory, or any combination. System memory 2004 may include operating system 2005, one or more programming modules 2006, and may include a program data 2007. Operating system 2005, for example, may be suitable for controlling computing device 2000's operation. In one embodiment, programming modules 2006 may include image-processing module, machine learning module. Furthermore, embodiments of the disclosure may be practiced in conjunction with a graphics library, other operating systems, or any other application program and may be not limited to any particular application or system. This basic configuration may be illustrated in FIG. 20 by those components within a dashed line 2008.

Computing device 2000 may have additional features or functionality. For example, computing device 2000 may also include additional data storage devices (removable and/or non-removable) such as, for example, magnetic disks, optical disks, or tape. Such additional storage may be illustrated in FIG. 20 by a removable storage 2009 and a non-removable storage 2010. Computer storage media may include volatile and non-volatile, removable and non-removable media implemented in any method or technology for storage of information, such as computer-readable instructions, data structures, program modules, or other data. System memory 2004, removable storage 2009, and non-removable storage 2010 are all computer storage media examples (i.e., memory storage.) Computer storage media may include, but may be not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 2000. Any such computer storage media may be part of device 2000. Computing device 2000 may also have input device(s) 2012 such as a keyboard, a mouse, a pen, a sound input device, a touch input device, a location sensor, a camera, a biometric sensor, etc. Output device(s) 2014 such as a display, speakers, a printer, etc. may also be included. The aforementioned devices are examples and others may be used.

Computing device 2000 may also contain a communication connection 2016 that may allow device 2000 to communicate with other computing devices 2018, such as over a network in a distributed computing environment, for example, an intranet or the Internet. Communication connection 2016 may be one example of communication media. Communication media may typically be embodied by computer-readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer-readable media as used herein may include both storage media and communication media.

As stated above, a number of program modules and data files may be stored in system memory 2004, including operating system 2005. While executing on processing unit 2002, programming modules 2006 (e.g., application 2020 such as a media player) may perform processes including, for example, one or more stages of methods, algorithms, systems, applications, servers, databases as described above. The aforementioned process may be an example, and processing unit 2002 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general-purpose graphics processor-based systems, multiprocessor systems, microprocessor-based or programmable consumer electronics, application-specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit may include discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer-readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example, but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program may be printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may, in fact, be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid-state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it may be to be understood that many other possible modifications and variations can be made without departing from the spirit and scope of the disclosure.

The following is claimed:

1. A washing system comprising:
a frame configured to be arranged in a plurality of frame configurations, wherein at least one operational frame configuration of the plurality of frame configurations comprises a passageway, wherein the passageway is configured to partly encompass at least one object;
at least one brush coupled to the frame, wherein the at least one brush is configured to perform at least one brushing action on the at least one object;
at least one cleaning agent dispenser mounted on the frame, wherein the at least one cleaning agent dispenser is configured to perform at least one cleaning agent dispensing action, wherein the at least one cleaning agent dispenser comprises at least one inlet port and at least one outlet port, wherein the at least one inlet port and the at least one outlet port is fluidly coupled, wherein the at least one inlet port is configured to receive at least one cleaning agent, wherein the at least one outlet port is configured to dispense the at least one cleaning agent;
a plurality of wheels mounted on the frame, wherein the plurality of wheels is configured to facilitate the movement of the frame on a surface in at least one direction;
at least one actuator operationally coupled with the at least one wheel, wherein the at least one actuator is configured to perform at least one actuator operation, wherein the at least one actuator operation comprises rotating the at least one wheel;
a power source electrically coupled with the at least one actuator, wherein the power source is configured to provide electrical power to the at least one actuator; and
a controller communicatively coupled with the at least one actuator, wherein the controller is configured to control the at least one actuator.

2. The washing system of claim 1, wherein the frame comprises at least one arranging mechanism, wherein the at least one arranging mechanism facilitates arranging the frame in the plurality of frame configurations, wherein the plurality of frame configurations comprises a collapsed frame configuration and the at least one operational frame configuration, wherein the collapsed frame configuration does not comprise the passageway.

3. The washing system of claim 2, wherein the at least one actuator is operationally coupled with a collapsing mechanism of the at least one arranging mechanism, wherein the at least one actuator operation comprises transitioning the frame between the collapsed frame configuration and the at least one operational frame configuration.

4. The washing system of claim 3 further comprising at least one input device communicatively coupled with the controller over at least one of a wired communication channel and a wireless communication channel, wherein the at least one input device is configured to receive at least one input command associated with the plurality of frame configurations, wherein the controller is configured to control the at least one actuator based on the at least one input command.

5. The washing system of claim 1, wherein the at least one object is associated with at least one object configuration, wherein the frame is configured to move through a plurality of object positions in relation to the at least one object, wherein the plurality of object positions corresponds to a plurality of object shapes, wherein the at least one object configuration is associated with an object shape of the plurality of object shapes corresponding an object position of the plurality of object positions, wherein the frame is configured to be arranged in the at least one operational frame configuration according to the at least one object configuration.

6. The washing system of claim 2, wherein the at least one actuator is operationally coupled with the at least one arranging mechanism, wherein the at least one actuator operation comprises arranging the frame in the at least one operational frame configuration.

7. The washing system of claim 6 further comprising at least one object sensor mounted on the frame, wherein the at least one object sensor is communicatively coupled with the controller, wherein the at least one object sensor is configured to generate at least one object sensor data corresponding the at least one object, wherein the controller is configured to control the at least one actuator based on the at least one object sensor data.

8. The washing system of claim 1, wherein the at least one cleaning agent dispenser comprises at least one detergent dispenser and at least one water dispenser, wherein the at least one detergent dispenser is configured to dispense at least one detergent and at least one water dispenser is configured to dispense water.

9. The washing system of claim 1, wherein the at least one cleaning agent dispenser is configured to dispense at least one detergent and water.

10. The washing system of claim 1, wherein the at least one actuator is operationally coupled with the at least one cleaning agent dispenser, wherein the at least one actuator operation comprises performing the at least one cleaning agent dispensing action.

11. The washing system of claim 10 further comprising at least one cleaning agent sensor mounted on the frame, wherein the at least one cleaning agent sensor is communicatively coupled with the controller, wherein the at least one cleaning agent sensor is configured to generate at least one cleaning agent sensor data corresponding to the at least one object, wherein the controller is configured to control the at least one actuator based on the at least one cleaning agent sensor data.

12. The washing system of claim 1, wherein the at least one inlet port is fluidly coupled with at least one external cleaning agent source, wherein the at least one inlet port is configured to receive the at least one cleaning agent from the at least one external cleaning agent source, wherein the at least one outlet port is configured to dispense the at least one cleaning agent.

13. The washing system of claim 1, wherein the at least one inlet port is fluidly coupled with at least one cleaning agent cartridge, wherein the at least one cleaning agent cartridge is detachably disposed in the frame, wherein the at least one cleaning agent cartridge comprises at least one container configured to store the at least one cleaning agent, wherein the at least one inlet is configured to receive the at least one cleaning agent from the at least one cleaning agent cartridge, wherein the at least one outlet port is configured to dispense the at least one cleaning agent.

14. The washing system of claim 1, wherein the at least one brush is movably coupled to the frame using at least one brush-movement mechanism, wherein the at least one brush-movement mechanism is configured to provide at least one brush movement to the at least one brush, wherein the at least one brush movement facilitates the at least one brushing action on the at least one object.

15. The washing system of claim 14, wherein the at least one actuator is operationally coupled with the at least one brush-movement mechanism and the at least one brush, wherein the at least one actuator operation comprises providing the at least one brush movement to the at least one brush, wherein the at least one actuator operation comprises performing the at least one brushing action.

16. The washing system of claim 15 further comprising at least one brush sensor mounted on the frame, wherein the at least one brush sensor is communicatively coupled with the controller, wherein the at least one brush sensor is configured to generate at least one brush sensor data corresponding to the at least one object, wherein the controller is configured to control the at least one actuator based on the at least one brush sensor data.

17. A washing system comprising:
a frame configured to be arranged in a plurality of frame configurations, wherein at least one operational frame configuration of the plurality of frame configurations comprises a passageway, wherein the passageway is configured to partly encompass at least one object;
at least one brush movably coupled to the frame using at least one brush-movement mechanism, wherein the at least one brush is configured to perform at least one brushing action on the at least one object, wherein the at least one brush-movement mechanism is configured to provide at least one brush movement to the at least one brush, wherein the at least one brush movement facilitates the at least one brushing action;
at least one cleaning agent dispenser mounted on the frame, wherein the at least one cleaning agent dispenser is configured to perform at least one cleaning agent dispensing action, wherein the at least one cleaning agent dispenser comprises at least one inlet port and at least one outlet port, wherein the at least one inlet port and the at least one outlet port is fluidly coupled, wherein the at least one inlet port is configured to receive at least one cleaning agent, wherein the at least one outlet port is configured to dispense the at least one cleaning agent;
a plurality of wheels mounted on the frame, wherein the plurality of wheels is configured to facilitate the movement of the frame on a surface in at least one direction;
at least one actuator operationally coupled with the at least one wheel, wherein the at least one actuator is configured to perform at least one actuator operation, wherein the at least one actuator operation comprises rotating the at least one wheel;
a power source electrically coupled with the at least one actuator, wherein the power source is configured to provide electrical power to the at least one actuator; and
a controller communicatively coupled with the at least one actuator, wherein the controller is configured to control the at least one actuator.

18. The washing system of claim 17, wherein the frame comprises at least two leg bars and at least one head bar, wherein a frame configuration of the plurality of frame configurations comprises the at least two leg bars positioned parallelly and the at least one head bar positioned perpendicularly in relation to the at least two leg bars.

19. The washing system of claim 17, wherein the frame comprises a collapsing mechanism, wherein the collapsing mechanism is configured for arranging the frame in the plurality of frame configurations, wherein the plurality of frame configurations comprises a collapsed frame configuration and the at least one operational frame configuration, wherein the collapsed frame configuration may not comprise the passageway.

20. The washing system of claim 17, wherein the at least one object is associated with at least one object configuration, wherein the frame is configured to move through a plurality of object positions in relation to the at least one object, wherein the plurality of object positions corresponds to a plurality of object shapes, wherein the at least one object configuration is associated with an object shape of the plurality of object shapes corresponding an object position of the plurality of object positions, wherein the frame is configured to be arranged in the at least one operational frame configuration according to the at least one object configuration.
